(19) United States
(12) Patent Application Publication
(10) Pub. No.: US 2026/0008170 A1
(43) Pub. Date: Jan. 8, 2026

(54) UNIVERSAL ADAPTIVE GRIP HANDLE DEVICE FOR SMALL HANDHELD TOOLS

(71) Applicant: Gripz, LLC, Silver Spring, MD (US)

(72) Inventors: Craig Sherwood Mackel, Silver Spring, MD (US); Lynn J. Rust, Silver Spring, MD (US); Robert J. Collins, Horace, ND (US)

(21) Appl. No.: 19/261,769

(22) Filed: Jul. 7, 2025

Related U.S. Application Data
(60) Provisional application No. 63/668,613, filed on Jul. 8, 2024.

(51) Int. Cl. B25G 1/10; B25G 3/10

(52) U.S. Cl. CPC B25G 1/102; B25G 3/10

(57) ABSTRACT

In one or more embodiments, an adaptive grip handle device for handheld tools with a narrow-diameter handle and a method for providing the same are disclosed. The adaptive grip handle device includes a rounded grip handle with an opening that allows insertion of the small handheld tool wherein the opening includes any of: an adjustable bore, a flexible bore, a flexible slit, a flexible cross slit, or a combination thereof, to grip a range of handle sizes, or a two-part device consisting of a hard outer shell and a flexible insert including a bore, slit, a cross slit or a combination thereof, and wherein the bore, the slit, the cross slit or a combination thereof either extends the length of the device or part of the length of the device depending on the tool it is designed to be used with.

### CROSS-REFERENCE TO RELATED APPLICATION

This application claims priority under 35 USC 119 (e) to U.S. Provisional Application No. 63/668,613, filed Jul. 8, 2024, entitled “A UNIVERSAL ADAPTIVE GRIP HANDLE DEVICE FOR SMALL HANDHELD TOOLS”, all of which is incorporated herein by reference in its entirety.

### FIELD OF THE INVENTION

The embodiments described herein relate generally to an adaptive grip handle device and more particularly to adaptive grip handle device for small handheld tools or handheld tools with a narrow-diameter handle.

### SUMMARY

In one or more embodiments, an adaptive grip handle device for small handheld tools or handheld tools with a narrow-diameter handle and a method for providing an adaptive grip handle device for small handheld tools or handheld tools with a narrow-diameter handle are disclosed.

In one or more embodiments, the adaptive grip handle device for small handheld tools or handheld tools with a narrow-diameter handle includes a rounded grip handle with an opening that allows insertion of the small handheld tool, wherein the opening for insertion includes any of: adjustable bore, a flexible bore, a flexible slit, a flexible cross slit or a combination thereof, to grip a range of handle sizes, and wherein the bore and/or slit either extends the length of the device so that the opening is accessible at either end of the grip handle device or part of the length of the device depending on the small handheld tool it is designed to be used with.

In one or more embodiments, the adaptive grip handle device for small, handheld tools or handheld tools with a narrow-diameter handle including any of adjustable bore, a flexible bore, a flexible slit, a flexible cross slit, or a combination thereof within the adaptive grip handle device is designed to accommodate a small, long-handled handheld tool.

In one or more embodiments, the adaptive grip handle device for small, handheld tools or handheld tools with a narrow-diameter handle is provided as either egg-shaped or spherical shaped device with any of adjustable bore, a flexible bore, a flexible slit, a flexible cross slit or a combination thereof, to accommodate a range of cylindrical or flat-handled tool dimensions.

In one or more embodiments, the adaptive grip handle device for small, handheld tools or handheld tools with a narrow-diameter handle is made of a material that can be autoclaved between uses.

In one or more embodiments, the adaptive grip handle device for small, handheld tools or handheld tools with a narrow-diameter handle is disposable.

In one or more embodiments, the adaptive grip handle device for small, handheld tools or handheld tools with a narrow-diameter handle is reusable. In one or more embodiments, the adaptive grip handle device for small, handheld tools or handheld tools with a narrow-diameter handle is adapted for use with a long-handled device including a paintbrush, a crochet needle, a dental instrument, an eating utensil, writing instrument, a golf club, etc.

In one or more embodiments, the adaptive grip handle device for small, handheld tools or handheld tools with a narrow-diameter handle is adapted for use with a guitar pick.

In one or more embodiments, the adaptive grip handle device for small, handheld tools or handheld tools with a narrow-diameter handle is designed to open and close lengthwise to accommodate two-ended tools such as dental instruments.

In one or more embodiments, the adaptive grip handle device for small, handheld tools or handheld tools with a narrow-diameter handle is designed to be textured for grip surety.

In one or more embodiments, the adaptive grip handle device for small, handheld tools or handheld tools with a narrow-diameter handle adapted for use with tools includes a hard outer shell and a flexible insert further including any of a bore, a slit, a cross slit, or a combination thereof, to accommodate a range of cylindrical or flat-handled tool dimensions.

In one or more embodiments, the adaptive grip handle device for small, handheld tools or handheld tools with a narrow-diameter handle including a hard outer shell and a flexible insert is adapted for use with a guitar pick.

In one or more embodiments, the adaptive grip handle device for handheld tools with a narrow diameter handle including a hard outer shell and a flexible insert is adapted for use with a handheld tool with a narrow diameter such as paintbrush, a crochet needle, a dental instrument, an eating utensil, writing instrument, golf club.

In one or more embodiment, the outside of the adaptive grip handle device is designed to result in a palmar abduction of the thumb of 40°-57°.

In one or more embodiments, the method for providing an adaptive grip handle device for small handheld tools or handheld tools with a narrow-diameter handle includes providing a rounded grip handle with an opening that allows insertion of the small handheld tool, wherein the bore or a slit for insertion includes any of: adjustable bore, a flexible bore, a flexible slit, a flexible cross slit, or a combination thereof, to grip a range of handle sizes, and wherein the bore, slit, the cross slit or a combination thereof is provided such that it either extends the length of the device so that the opening is accessible at either end of the adaptive grip handle device or part of the length of the adaptive grip handle device depending on the small handheld tool it is designed to be used with.

In one or more embodiments, the method for providing an adaptive grip handle device for small, handheld tools or handheld tools with a narrow-diameter handle any of: adjustable bore, a flexible bore, a flexible slit, a flexible cross slit, or a combination thereof, within the adaptive grip handle to accommodate a small, long-handled handheld tool or handheld tools with a narrow-diameter handle.

In one or more embodiments, the method for providing an adaptive grip handle device for small, handheld tools or handheld tools with a narrow-diameter handle includes 3D-printing either shaped or spherical shaped device with any of: adjustable bore, a flexible bore, a flexible slit, a flexible cross slit, or a combination thereof, to accommodate a range of cylindrical or flat-handled tool dimensions.

In one or more embodiments, the method for providing an adaptive grip handle device for small, handheld tools or handheld tools with a narrow-diameter handle includes providing a mechanism to open and close the rounded grip handle with any of: adjustable bore, a flexible bore, a flexible slit, a flexible cross slit, or a combination thereof, lengthwise to accommodate two-ended tools such as dental instruments.

In one or more embodiments, the method for providing an adaptive grip handle device for small, handheld tools or handheld tools with a narrow-diameter handle includes providing a textured outer surface for grip surety.

In one or more embodiments, the method for providing an adaptive grip handle device for small handheld tools or handheld tools with a narrow-diameter handle includes providing the adaptive grip handle device for small handheld tools or handheld tools with a narrow-diameter handle as a two-part device including a hard outer shell and a flexible insert including any of: a bore, a slit, a cross slit, or a combination thereof, to accommodate a range of cylindrical or flat-handled tool dimensions.

In one or more embodiments, the method for providing an adaptive grip handle device for small, handheld tools or handheld tools with a narrow-diameter handle having a hard outer shell and a flexible insert includes adapting the device for use with a guitar pick.

In one or more embodiments, the method for providing an adaptive grip handle device for handheld tools with a narrow diameter handle having a hard outer shell and a flexible insert includes adapting the device for use with a handheld tool with a narrow diameter such as paintbrush, a crochet needle, a dental instrument, an eating utensil, writing instrument, golf club.

In one or more embodiment, the method for providing an adaptive grip handle device for small handheld tools or handheld tools with a narrow-diameter handle includes designing the outside of the adaptive grip handle to result in a palmar abduction of the thumb of 40°-57°.

### BRIEF DESCRIPTION OF THE DRAWINGS

FIGS. 1A and 1B illustrate an example method for providing an adaptive grip handle device for handheld tools with a narrow diameter handle according to one or more embodiments described herein.

FIGS. 2A-2D illustrate an example system including an egg-shaped adaptive grip handle device for small, long-handled handheld tools to fit a large hand according to one or more embodiments described herein.

FIGS. 2E-2H illustrate an example system including an egg-shaped adaptive grip handle device for small, long-handled handheld tools to fit a small hand according to one or more embodiments described herein.

FIGS. 21 and 2J illustrate an example system including an egg-shaped adaptive grip handle device for small, long-handled handheld tools or long-handled handheld tools with narrow diameter with adjustable bore according to one or more embodiments described herein.

FIGS. 3A-3D illustrate an example system including a spherical adaptive grip handle device for small, long-handled handheld tools to fit a large hand according to one or more embodiments described herein.

FIGS. 4A and 4B illustrate an example system including an adaptive grip handle device for small, long-handled handheld tools or handheld tools with a narrow-diameter handle such as a paintbrush according to one or more embodiments described herein.

FIGS. 5A and 5B illustrate example systems including an adaptive grip handle device for small, long-handled handheld tools or handheld tools with a narrow-diameter handle such as a crochet needle according to one or more embodiments described herein.

FIGS. 6A, 6B and 6C illustrate an example adaptive grip handle device for small handheld tools as a guitar pick according to one or more embodiments described herein.

FIGS. 7A through 7H illustrate an example adaptive grip handle device for small, long-handled handheld tools with narrow diameter such as dental instruments according to one or more embodiments described herein.

FIGS. 71 through 7K illustrate an example adaptive grip handle device for small, long-handled handheld tools with narrow diameter such as dental instruments according to one or more embodiments described herein.

FIG. 8A illustrates an example system including an adaptive grip handle device for small, long-handled handheld tools or handheld tools with a narrow-diameter handle such as eating utensils according to one or more embodiments described herein.

FIG. 8B illustrates an example system including an adaptive grip handle device for small, long-handled handheld tools or handheld tools with a narrow-diameter handle such as pencil according to one or more embodiments described herein.

FIGS. 9A and 9B illustrate an example system including an adaptive grip handle device for a long-handled handheld tools or handheld tools with a narrow-diameter handle such as golf club according to one or more embodiments described herein.

### DETAILED DESCRIPTION

The embodiments described herein relate generally to an adaptive grip handle device and more particularly to adaptive grip handle device for small handheld tools or handheld tools with a narrow-diameter handles.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

According to the CDC website, “Based on data from the National Health Interview Survey (NHIS), during 2019-2021, an estimated 53.2 million US adults (21.2%) had ever been told by a doctor (doctor-diagnosed) that they had some form of arthritis, rheumatoid arthritis, gout, lupus, or fibromyalgia.” (https://www.cdc.gov/nchs/products/databriefs/db497.htm).

The number of people suffering from hand osteoarthritis (HOA) is significant. Persons suffering from osteoarthritis of the thumb and fingers experience pain and worsening of disease from pinching the thumb and index finger together when using narrow-diameter, long-handled handheld tools such as paintbrushes, knitting needles, toothbrushes, combs, small knives, dental tools, eating utensils, writing instrument, golf club, and the like. This repeated and/or prolonged pinching action puts stress on the carpometacarpal (CMC) joint of the thumb, thus resulting in pain and potential worsening of disease.

Rigid or neoprene hand orthoses are strongly recommended for patients suffering from HOA, particularly of the CMC joint (https://acrjournals.onlinelibrary.wiley.com/doi/10.1002/acr.24131:2019 American College of Rheumatology/Arthritis Foundation Guideline for the Management of Osteoarthritis of the Hand, Hip, and Knee; First published: 6 Jan. 2020). Splints or braces support and protect the affected joint, reduce deformity, provide joint stability, lessen strain, and promote proper joint alignment (Cleveland Clinic; https://my.clevelandclinic.org/health/diseases/7082-arthritis-of-the-wrist-and-hand; Last reviewed on Jul. 6, 2021). Proper joint alignment in HOA of the CMC joint involves holding the thumb and fingers in a C, or “safe”, position. However, these orthoses often cannot be worn when using tools with a narrow-diameter handle.

Various methods and systems are used to provide an adaptive grip handle device and more particularly to adaptive grip handle device for small, long-handled handheld tools. The following embodiments described herein are unique and improved methods/devices that provide an adaptive grip handle device and more particularly to adaptive grip handle device for small, handheld tools or handheld tools with a narrow-diameter handle.

In one or more embodiments, an adaptive grip handle device for small handheld tools and a method for providing an adaptive grip handle device for small handheld tools are disclosed.

In one or more embodiments, the adaptive grip handle device for small handheld tools or handheld tools with a narrow-diameter handle includes a rounded grip handle with an opening that allows insertion of the small handheld tool or handheld tools with a narrow-diameter handle, wherein the opening for insertion includes any of: adjustable bore, a flexible bore, a flexible slit, a flexible cross slit, or a combination thereof, to grip a range of handle sizes, and wherein the bore, the slit, the cross slit or a combination thereof extends either the length of the device so that the opening is accessible at either end of the grip handle device or part of the length of the device depending on the small handheld tool it is designed to be used with.

In one or more embodiments, the adaptive grip handle device for small, handheld tools or handheld tools with a narrow-diameter handle includes any of: adjustable bore, a flexible bore, a flexible slit, a flexible cross slit, or a combination thereof, to accommodate a small, long-handled handheld tool.

In one or more embodiments, the adaptive grip handle device for small, handheld tools or handheld tools with a narrow-diameter handle is provided as either egg-shaped or spherical shaped device with any of: an adjustable bore, a flexible bore, a flexible slit, a flexible cross slit, or a combination thereof, to accommodate a range of cylindrical or flat-handled tool dimensions.

In one or more embodiments, the adaptive grip handle device for small, handheld tools or handheld tools with a narrow-diameter handle is made of a material that can be autoclaved between uses.

In one or more embodiments, the adaptive grip handle device for small, handheld tools or handheld tools with a narrow-diameter handle is disposable.

In one or more embodiments, the adaptive grip handle device for small, handheld tools is reusable.

In one or more embodiments, the adaptive grip handle device for small, handheld tools or handheld tools with a narrow-diameter handle is adapted for use with a long-handled device including a paintbrush, a crochet needle, a dental instrument, eating utensils, writing instrument, golf club, etc.

In one or more embodiments, the adaptive grip handle device for small, handheld tools is adapted for use with a guitar pick.

In one or more embodiments, the adaptive grip handle device for small, handheld tools or handheld tools with a narrow-diameter handle is designed to open and close lengthwise to accommodate two-ended tools such as dental instruments.

In one or more embodiments, the adaptive grip handle device for small, handheld tools or handheld tools with a narrow-diameter handle is designed to be textured for grip surety.

In one or more embodiments, the adaptive grip handle device for small, handheld tools or handheld tools with a narrow-diameter handle adapted for use with tools includes a hard outer shell and a flexible insert including any of: a bore, a slit, a cross slit, or a combination thereof, to accommodate a range of cylindrical or flat-handled tool dimensions.

In one or more embodiments, the adaptive grip handle device for small, handheld tools or handheld tools with a narrow-diameter handle including a hard outer shell and a flexible insert is adapted for use with a guitar pick.

In one or more embodiments, the adaptive grip handle device for handheld tools with a narrow diameter handle including a hard outer shell and a flexible insert is adapted for use with a handheld tool with a narrow diameter such as paintbrush, a crochet needle, a dental instrument, an eating utensil, writing instrument, golf club.

In one or more embodiment, the outside of the adaptive grip handle device is designed to result in a palmar abduction of the thumb of 40°-57°.

In one or more embodiments, the method for providing an adaptive grip handle device for small handheld tools or handheld tools with a narrow-diameter handle includes providing a rounded grip handle with an opening that allows insertion of the small handheld tool, and wherein the opening for insertion includes any of: adjustable bore, a flexible bore, a flexible slit, a flexible cross slit, or a combination thereof, to grip a range of handle sizes, and wherein the bore and/or slit and/or cross slit is provided such that it either extends the length of the device so that the opening is accessible at either end of the adaptive grip handle device or part of the length of the adaptive grip handle device depending on the small handheld tool it is designed to be used with.

In one or more embodiments, the method for providing an adaptive grip handle device for small, handheld tools or handheld tools with a narrow-diameter handle includes providing any of: an adjustable bore, a flexible bore, a flexible slit, a flexible cross slit, or a combination thereof, within the adaptive grip handle to accommodate a small, long-handled handheld tool or handheld tools with a narrow-diameter handle.

In one or more embodiments, the method for providing an adaptive grip handle device for small, handheld tools or handheld tools with a narrow-diameter handle includes providing either egg-shaped or spherical shaped device with any of: an adjustable bore, a flexible bore, a flexible slit, a flexible cross slit, or a combination thereof, to accommodate a range of cylindrical or flat-handled tool dimensions.

In one or more embodiments, the method for providing an adaptive grip handle device for small, handheld tools or handheld tools with a narrow-diameter handle includes providing a mechanism to open and close the rounded grip handle with a bore or a slit lengthwise to accommodate two-ended tools such as dental instruments.

In one or more embodiments, the method for providing an adaptive grip handle device for small, handheld tools or handheld tools with a narrow-diameter handle includes providing a textured outer surface for grip surety.

In one or more embodiments, the method for providing an adaptive grip handle device for small handheld tools or handheld tools with a narrow-diameter handle includes providing the adaptive grip handle device for small handheld tools as a two-part device including a hard outer shell and a flexible insert including any of: a bore, a slit, a cross slit, or a combination thereof, to accommodate a range of cylindrical or flat-handled tool dimensions.

In one or more embodiments, the method for providing an adaptive grip handle device for small, handheld tools or handheld tools with a narrow-diameter handle having a hard outer shell and a flexible insert includes adapting the device for use with a guitar pick.

In one or more embodiments, the method for providing an adaptive grip handle device for handheld tools with a narrow diameter handle having a hard outer shell and a flexible insert includes adapting the device for use with a handheld tool with a narrow diameter such as paintbrush, a crochet needle, a dental instrument, an eating utensil, writing instrument, golf club.

In one or more embodiment, the method for providing an adaptive grip handle device for small handheld tools or handheld tools with a narrow-diameter handle includes designing the outside of the adaptive grip handle to result in a palmar abduction of the thumb of 40°-57°.

The purpose of this device/system and method is to reduce the pain of osteoarthritis encountered when using these tools by adapting the user's grip to a more comfortable position in which the thumb and fingers form a rounded or C-conformation (“safe” position). The device prevents the user from pinching the thumb and forefinger when using these narrow-diameter, long-handled tools. A person skilled in the art may readily understand that this device/method could be utilized in a multitude of grip configurations and is within the spirit and scope of the present invention described herein.

Existing devices for use by persons suffering from osteoarthritis have various disadvantages since they are either adaptations of whole, individual tools; specific to one type of tool or class of tools; do not hold the user's hand in proper position for pain reduction; consist of a single, elastic material for both grip and tool insertion that would stress the CMC joint of the thumb through the user's tendency to squeeze an elastic grip; or, limit device functionality and user hand size and comfort by prescribing where thumb and fingers are placed on the grip.

The device as claimed and described herein provides one or more of the following advantages over the traditional devices described above: 1. The device, being rounded, may be designed to hold the user's thumb and index finger in a C-position, thus reducing the pain of osteoarthritis of the hand. 2. The device may not prescribe where the user places his or her thumb or fingers, so the user can determine the best position for his or her grip based on the task and the size of the user's hand. 3. The device may be rigid, preventing the user from stressing the CMC joint of the thumb by the user's tendency to squeeze an elastic grip. 4. The device may be designed to slide over a range of handle diameters, including slightly tapered handles, and remain in place via friction and foam compression during tool use. 5. The device may be used on the handle of any tool that fits into the flexible center bore (“universal”) or an adjustable bore or a bore that is both flexible and adjustable. 6. The device may be textured for grip surety. 7. The device may be designed to open and close lengthwise to accommodate two-ended dental instruments.

The device/system according to one or more embodiments described herein is easier to use as the device prevents the user from pinching the thumb and forefinger when using these narrow-diameter, long-handled tools or small handheld tools.

For example, using a goniometer, the angle of the palmar abduction of the CMC joint of the thumb is 42°+/−2° of the 1.5 inch diameter and 55°+/−2° of the 1.75 inch diameter; thus, the adaptive grip handle devices result in a palmar abduction of the thumb of 40°-57°. The adaptive grip handle device automatically puts the hand in the “C”, thumb abduction position, through the specified diameter range of the outside of the device.

The adaptive grip handle device providing “C” position thumb palmar abduction may reduce pain and disability in the thumb CMC joint and prevent thumb adduction contracture. Both thumb joint pain and disability and thumb adduction contracture occur among people afflicted with thumb CMC osteoarthritis. Pinching of the fingers and thumb exacerbates pressure on the trapezium and may lead to the development of osteoarthritis of the CMC joint. Abducting the thumb may reduce this pressure and thus may reduce the pain and disability associated with thumb osteoarthritis. Additionally, both thumb adduction contracture and CMC joint pain and disability may interfere with grip strength and fine precision pinch.

The adaptive grip handle devices described herein are designed to abduct the thumb CMC joint, thus may result in both: reducing pain and disability from osteoarthritis and preventing thumb adduction contracture, while enabling fine precision pinch function when using narrow-handled, handheld tools and utensils. This is in contrast to braces and other orthoses, which are designed to abduct the thumb but may restrict motion and prevent fine precision pinch.

The method and system described herein provides a spherical, egg-shape, or otherwise rounded grip handle of a suitable diameter, for example, 1.50-2.25 inch, including any of: adjustable bore, a flexible bore, a flexible slit, a flexible cross slit or a combination thereof, to grip a range of handle sizes. The bore and/or slit and/or cross slit may be adjustable and may extend the length of the device so that the opening is accessible at either end of the grip handle device or part of the length of the adaptive grip handle device depending on the small handheld tool it is designed to be used with.

In an embodiment, the design of the device allows a user to slide the flexible bore or slit or cross slit or a combination thereof of the device over the handle of the tool to be used. The user can control the location of the device along the tool handle. The device is capable of remaining in place at the desired location during tool use. Examples of implements or tools with which the device would work include but are not limited to: utensils (fork, knife, spoon); cooking, serving and carving implements (knives, serving spoons and forks, ladles, grilling utensils . . . ); guitar pick; artists' paintbrushes; crochet needles; writing utensils (pencils, pens, markers); dental instruments; golf clubs; and any such tools with a handle that is less than 1 inch diameter or width of the handle and at least 2 inch long.

The adaptive grip handle device may be 3D-printed to be either egg-shaped or spherical shaped device with adjustable bore, flexible bore, slit, cross slit or a combination thereof, to accommodate a range of cylindrical or flat-handled tool dimensions. The adaptive grip handle device may be manufactured using other manufacturing techniques, for example, using injection molding technique. A person skilled in the art may recognize that although 3D printing and injection molding are the two techniques noted here, other suitable techniques for manufacturing the adaptive grip handle device may be used and is also within the spirit and scope of this invention. In one or more embodiments, the bore, slit or cross-slit may be provided as a central bore, slit or cross-slit, or may be provided at a location based on the preferred placement of the handheld tool with the adaptive grip handle device based on the tools the device is designed to be used with.

The design of the adaptive grip handle device allows a user to slide the device over the handle of the tool of choice and position it at a desired location along the handle. The user may then grip the device, in either an overhand or underhand fashion, keeping the thumb and fingers in a C-position. The thumb and fingers may be placed in any orientation on the device that is comfortable for the user and appropriate to the task. The user may release the device when done using the tool. The user may choose to remove the device from the tool handle for storage or to use the device on a different tool, or the device may remain on that tool handle for the next use of that tool. For dental tool applications, the device can be autoclaved between uses or can be single-use-only or disposable.

In an embodiment, the adaptive grip handle device may be provided with an insert to accommodate tools with a handle that is less than 1 inch diameter or width, but are less than 2 inch long, for example, a guitar pick. For example, the adaptive grip handle device may be provided as a two-part device including a hard outer shell and a flexible insert including a bore, a slit, a cross slit, or a combination thereof. Additionally, or alternatively, in an embodiment, the insert may have an adjustable bore.

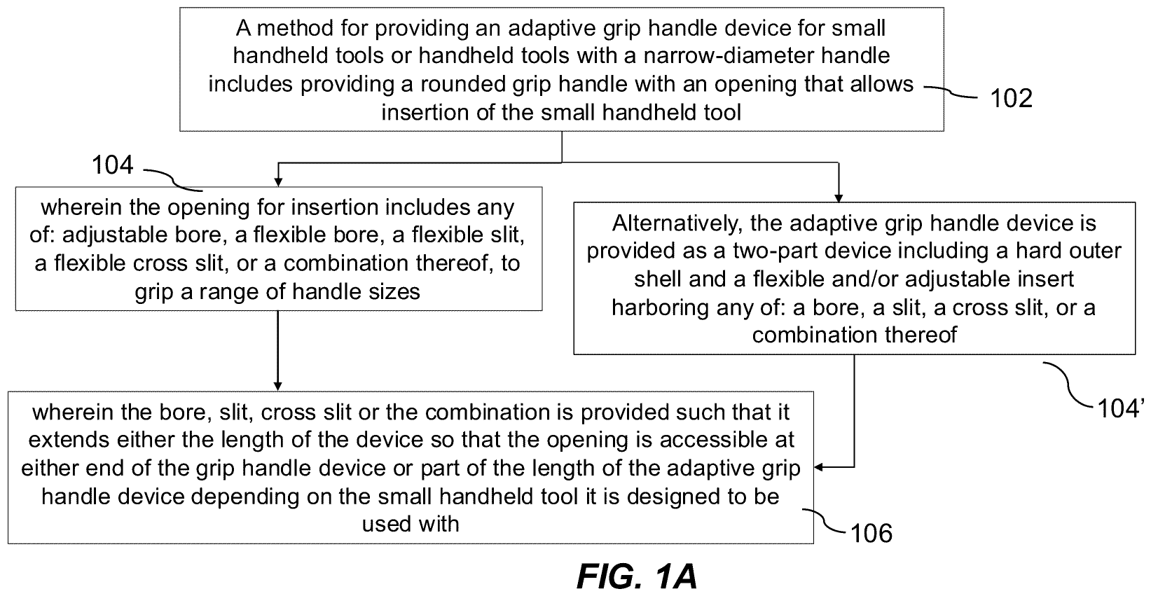

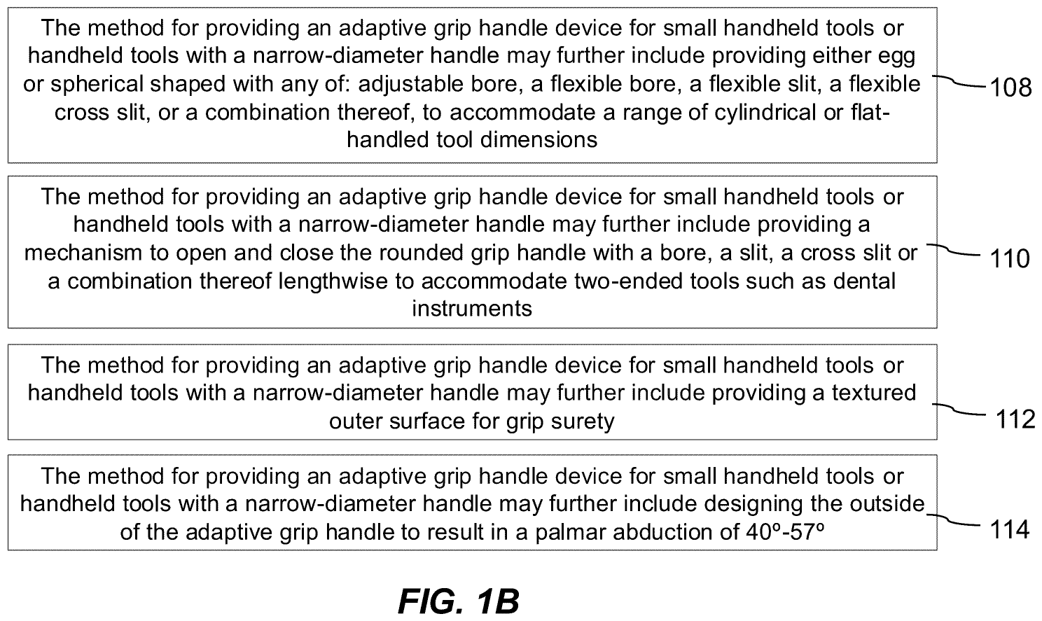

In any of the embodiments described herein, the adaptive grip handle device may be provided with a textured outer surface, for example, the outer surface may be fuzzy, or may be provided with some texture or indentation, for grip surety. FIGS. 1A and 1B illustrate an example method for providing an adaptive grip handle device for small handheld tools or handheld tools with a narrow diameter handle according to one or more embodiments described herein. In one or more embodiments, the method for providing an adaptive grip handle device for small handheld tools includes providing a rounded grip handle with an opening that allows insertion of the small handheld tool via step 102, wherein the opening for insertion includes any of: an adjustable bore, a flexible bore, a flexible slit, a flexible cross slit, or a combination thereof, to grip a range of handle sizes, step 104, and wherein the bore, slit, a cross slit or a combination thereof is provided such that it extends either the length of the device so that the opening is accessible at either end of the grip handle device or part of the length of the adaptive grip handle device depending on the small handheld tool it is designed to be used with, step 106.

Alternatively, in an embodiment, the adaptive grip handle device may be provided as a two-part device including a hard outer shell and a flexible and/or adjustable insert including a bore, a slit, a cross slit, or a combination thereof, via step 104′.

In one or more embodiments, the method for providing an adaptive grip handle device for small, handheld tools or handheld tools with a narrow-diameter handle includes providing either egg-shaped or spherical shaped device with any of: an adjustable bore, a flexible bore, a flexible slit, a flexible cross slit, or a combination thereof, to accommodate a range of cylindrical or flat-handled tool dimensions, step 108.

In one or more embodiments, the method for providing an adaptive grip handle device for small, handheld tools or handheld tools with a narrow-diameter handle includes providing a mechanism to open and close the rounded grip handle with a bore or a slit lengthwise to accommodate two-ended tools such as dental instruments, step 110.

In one or more embodiments, the method for providing an adaptive grip handle device for small, handheld tools or handheld tools with a narrow-diameter handle includes providing a textured outer surface for grip surety, step 112.

In one or more embodiment, the method for providing an adaptive grip handle device for small handheld tools or handheld tools with a narrow-diameter handle includes designing the outside of the adaptive grip handle to result in a palmar abduction of the thumb of 40°-57°, step 114.

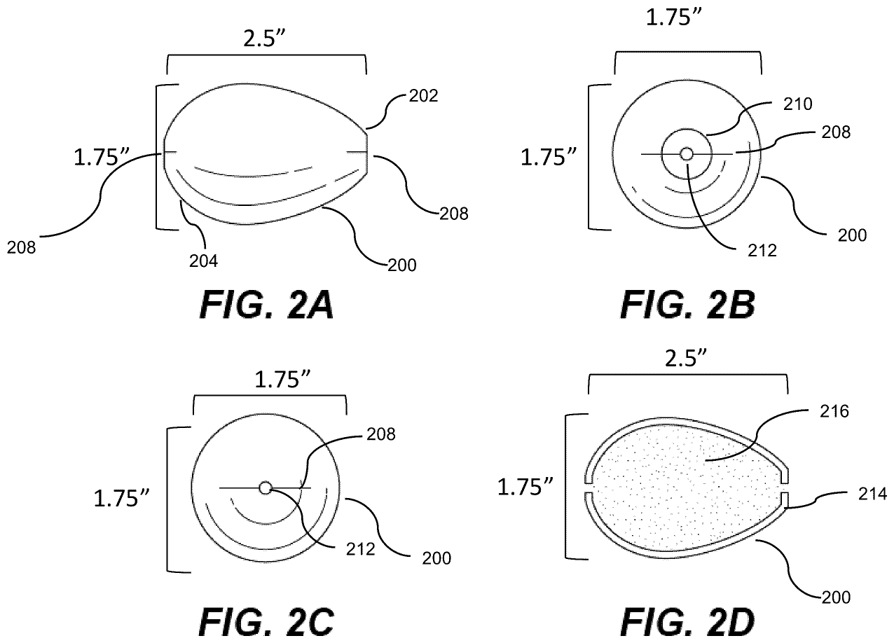

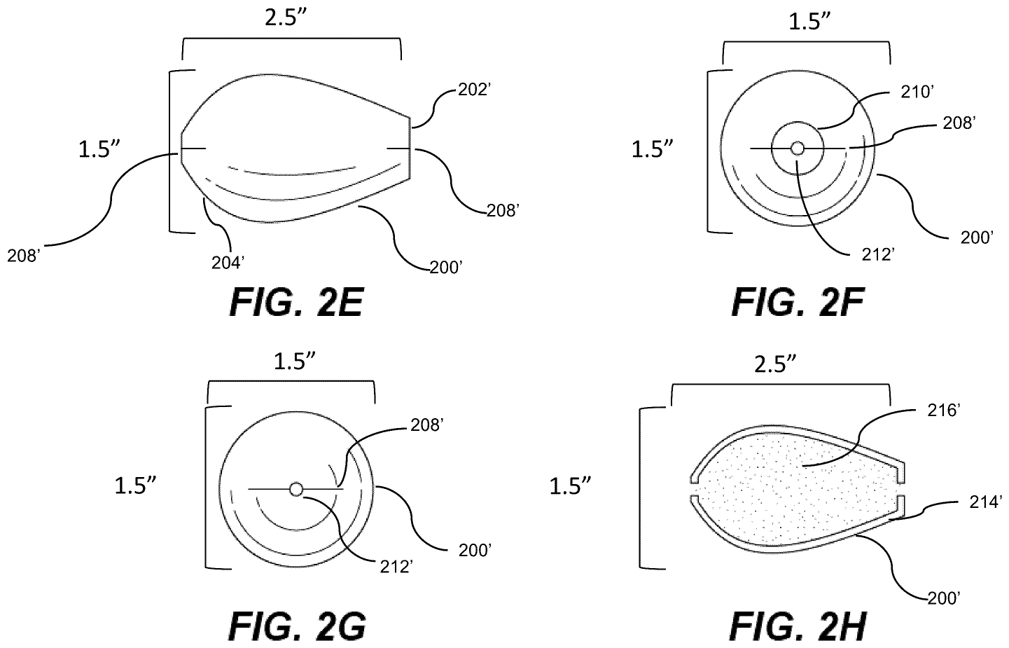

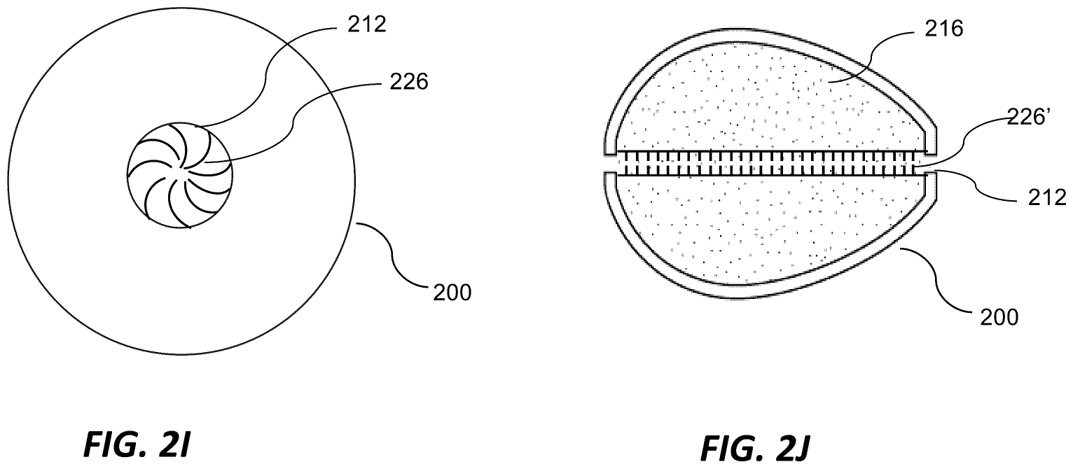

FIGS. 2A-2D illustrate an example system including an egg-shaped adaptive grip handle device for small, long-handled handheld tools or handheld tools with a narrow-diameter handle to fit a large hand according to one or more embodiments described herein. For example, FIG. 2A illustrates side view of an egg-shaped adaptive grip handle device 200 with a wide end 204 and a narrow end 202, provided with a slit 208 which may be further provided with a hole as shown in FIG. 2B, to accommodate small, handheld tool or handheld tools with a narrow-diameter handle. For example, the width of the wide end 204 may be 1.75 inches and the length of the device may be 2.5 inches.

FIG. 2B illustrates a view of the egg-shaped adaptive grip handle device 200 from the narrow end 202 of the device 200, showing a hole 212 which may be 2 mm to 15 mm or more, and/or a slit which may be 1.12 inch long and 1-3 mm wide, depending on the dimensions of the small, handheld tool or handheld tools with a narrow-diameter handle that the device 200 is designed to hold.

FIG. 2C illustrates a view of the egg-shaped adaptive grip handle device 200 from the wide end 204 of the device 200, showing a hole 212 which may be 2 mm to 15 mm or more, and/or a slit which may be 1.12 inch long and 1-3 mm wide, depending on the dimensions of the small, handheld tool or handheld tools with a narrow-diameter handle that the device 200 is designed to hold.

FIG. 2D illustrates a cross-sectional view of the egg-shaped adaptive grip handle device 200 showing a wall 214 and a hollow interior 216. Although the hollow interior is illustrated here, the interior of the adaptive grip handle device 200′ may be hollow or solid.

FIGS. 2E-2H illustrate an example system including an egg-shaped adaptive grip handle device for small, long-handled handheld tools or handheld tools with a narrow-diameter handle to fit a small hand according to one or more embodiments described herein. For example, FIG. 2E illustrates side view of an egg-shaped adaptive grip handle device 200′ with a wide end 204′ and a narrow end 202′, provided with a slit 208′ which may be further provided with a hole as shown in FIG. 2E, to accommodate small, handheld tool or handheld tools with a narrow-diameter handle. For example, the width of the wide end 204 may be 1.5 inches and the length of the device may be 2.5 inches.

FIG. 2E Illustrates a side view of the egg-shaped adaptive grip handle device 200′, showing a hole 212′ which may be 2 mm to 15 mm or more, and/or a slit 208′ which may be 1.12 inch long and 1-3 mm wide, depending on the dimensions of the small, handheld tool or handheld tools with a narrow-diameter handle that the device 200′ is designed to hold.

FIG. 2F illustrates a view of the egg-shaped adaptive grip handle device 200′ from the narrow end 202′ of the device 200′, showing a hole 212′ which may be 2 mm to 15 mm or more, and/or a slit 208′ which may be 1.12 inch long and 1-3 mm wide, depending on the dimensions of the small, handheld tool or handheld tools with a narrow-diameter handle that the device 200′ is designed to hold.

FIG. 2G illustrates a view of the egg-shaped adaptive grip handle device 200 from the wide end 204′ of the device 200′, showing a hole 212′ which may be 2 mm to 15 mm or more, and/or a slit 208′ which may be 1.12 inch long and 1-3 mm wide, depending on the dimensions of the small, handheld tool or handheld tools with a narrow-diameter handle that the device 200′ is designed to hold.

FIG. 2H illustrates a cross-sectional view of the egg-shaped adaptive grip handle device 200′ showing a wall 214′ and a hollow interior 216′. Although the hollow interior is illustrated here, the interior of the adaptive grip handle device 200′ may be hollow or solid.

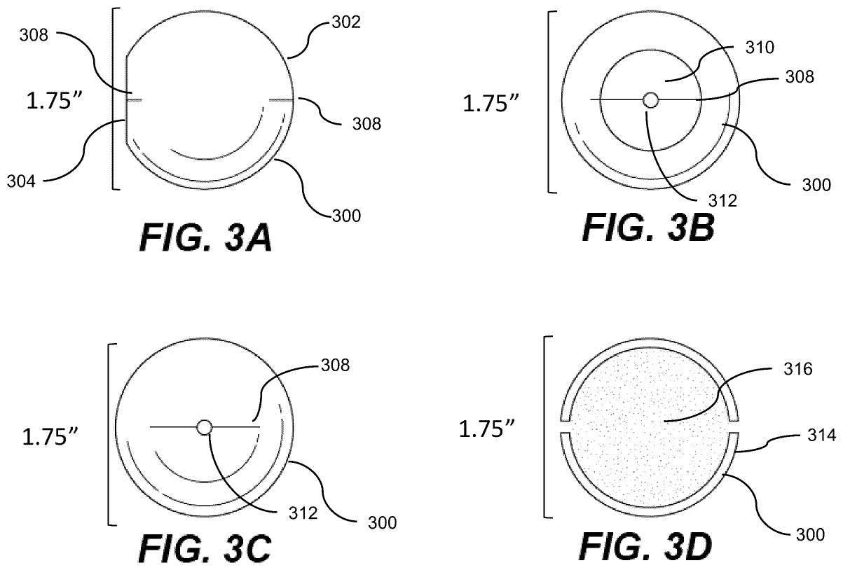

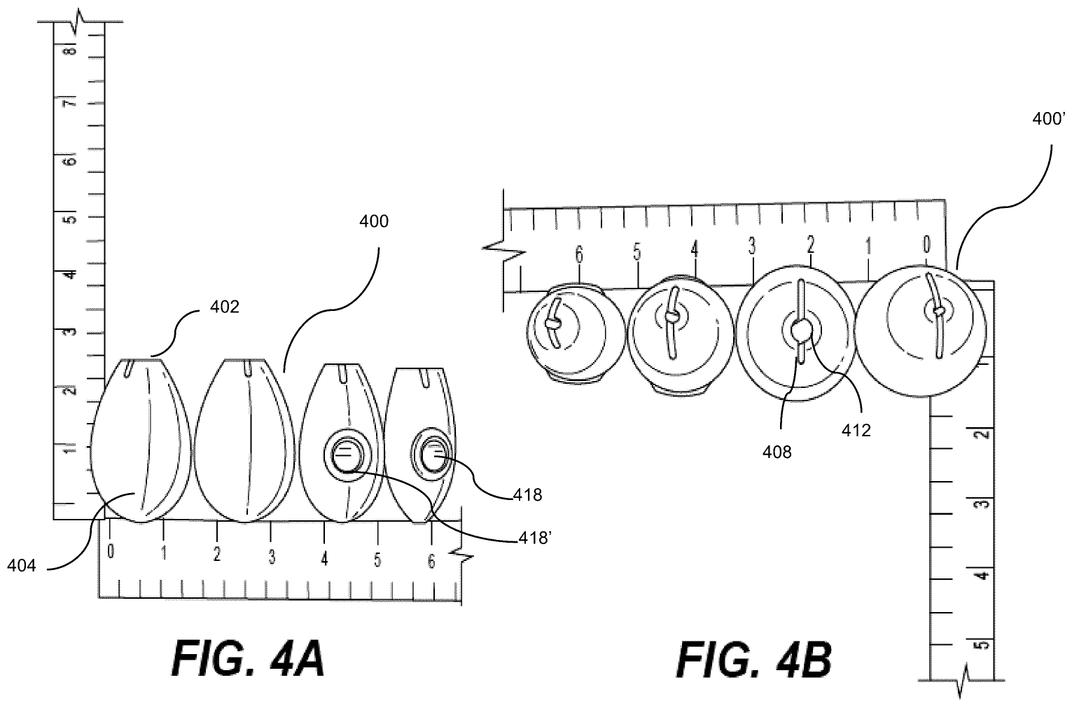

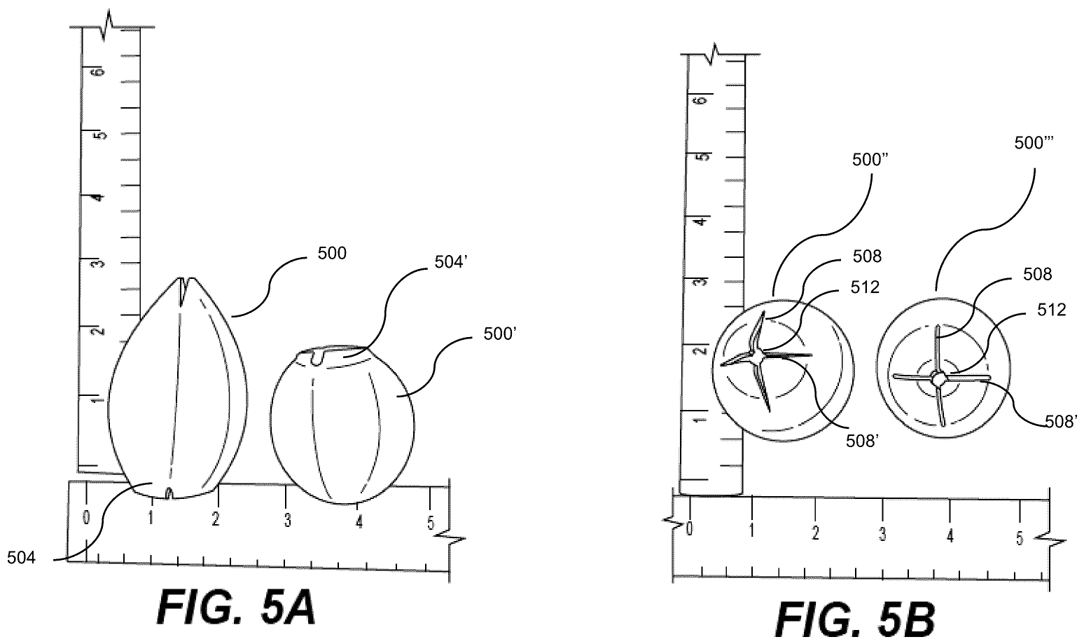

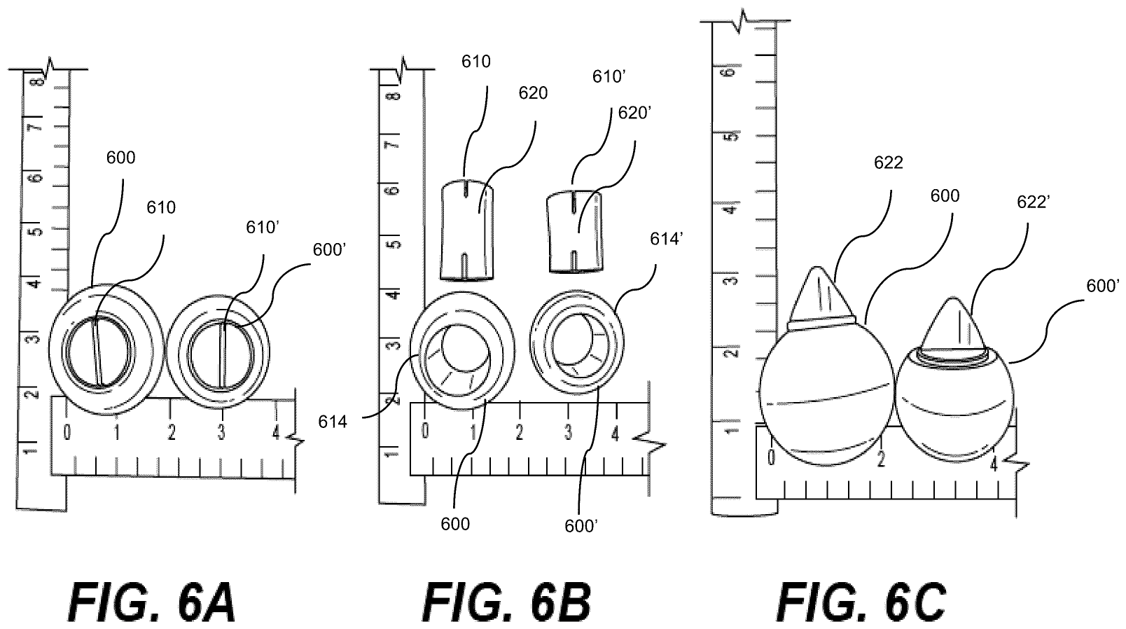

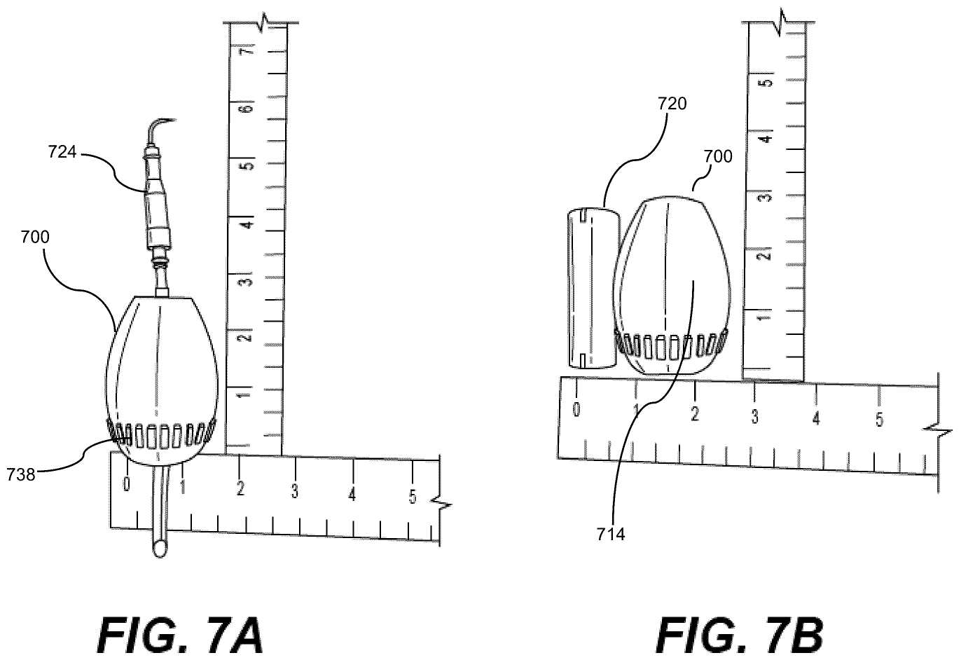

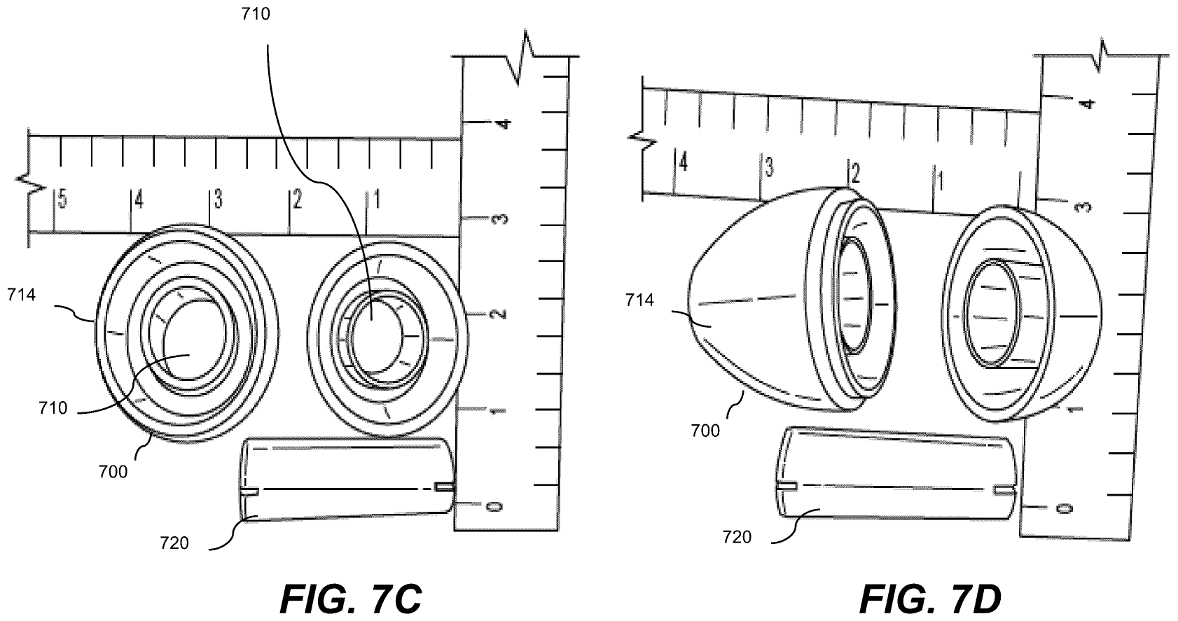

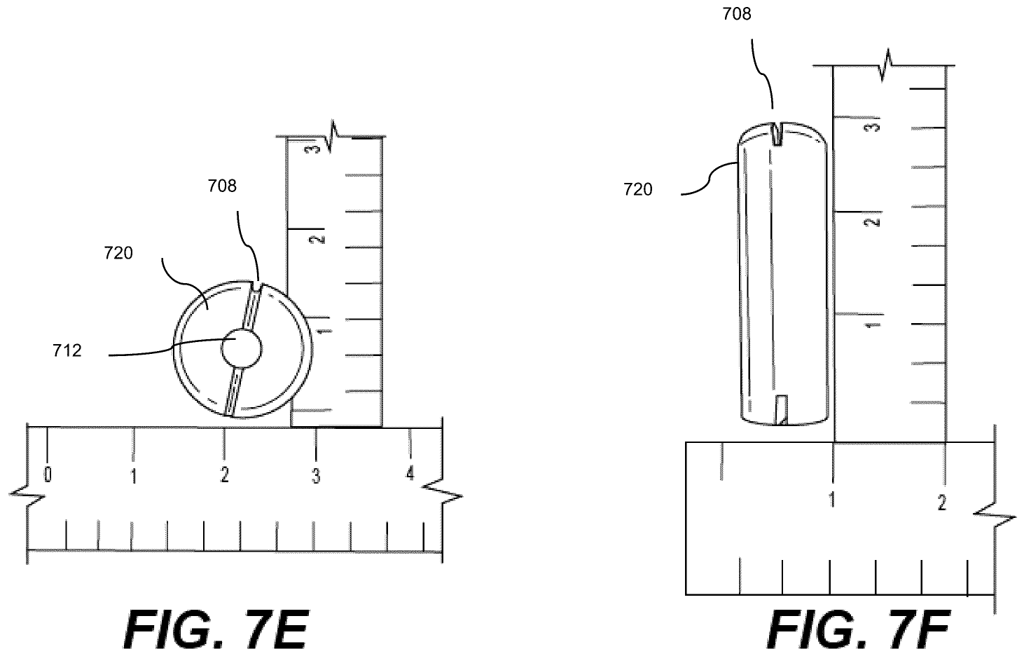

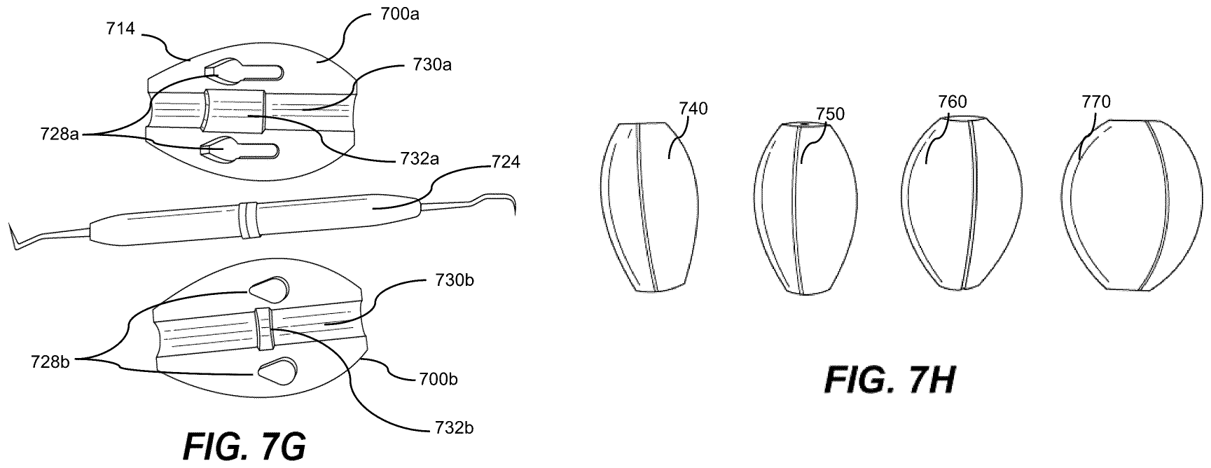

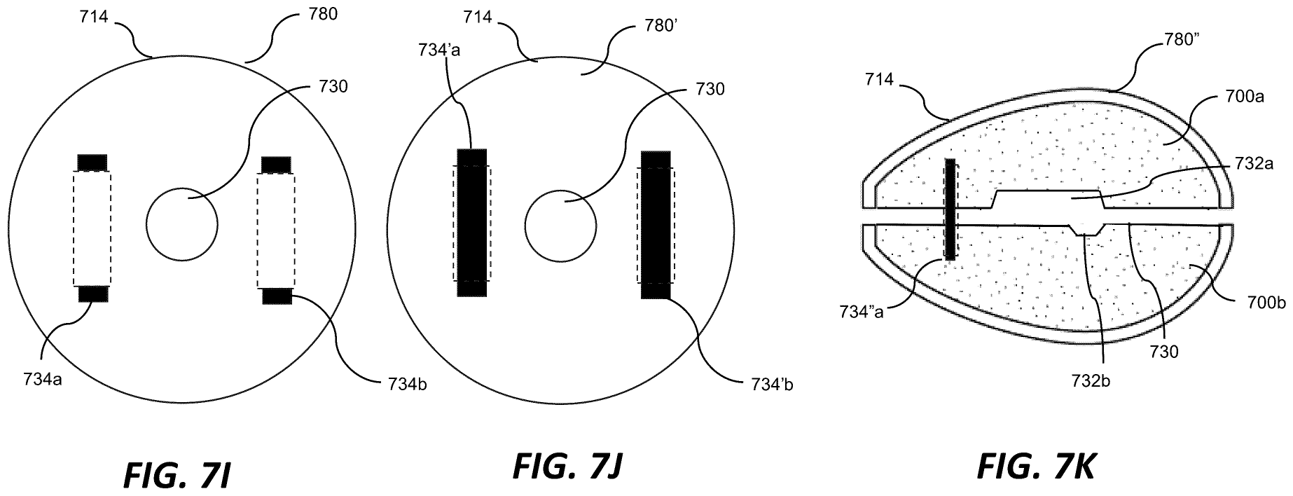

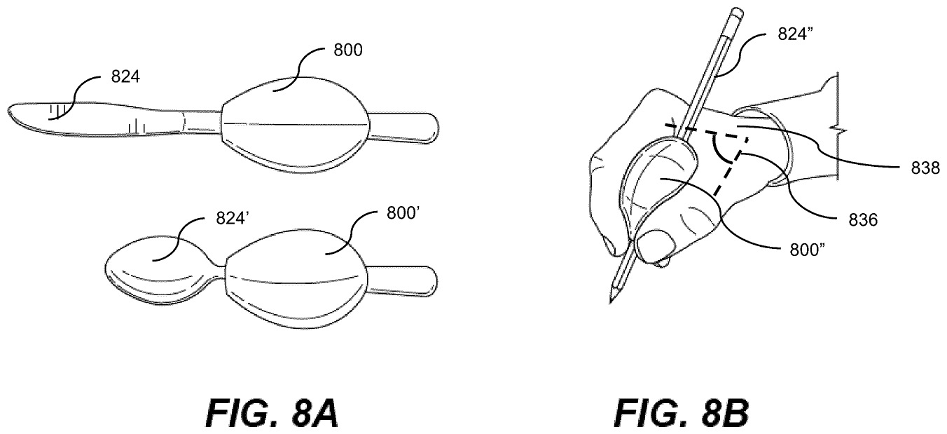

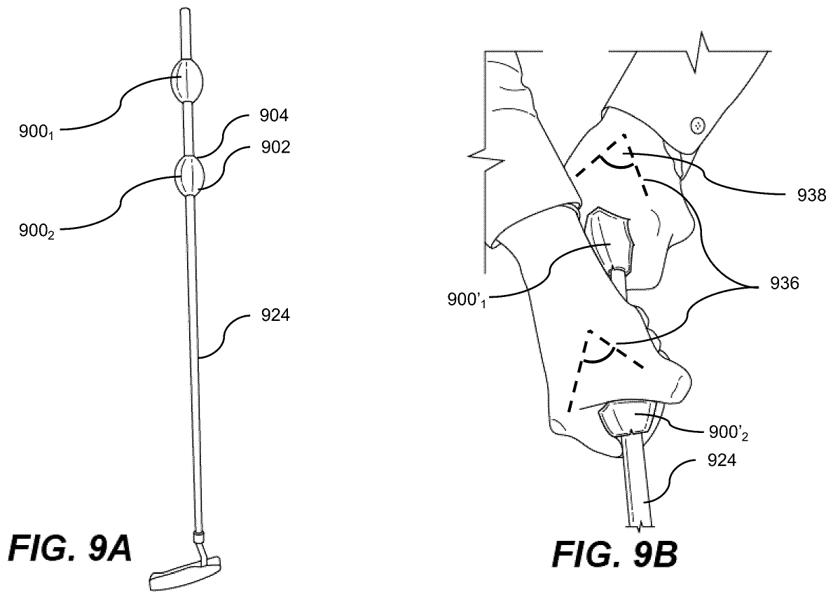

Additionally, or alternatively, the bore and/or slit and/or cross slit may be adjustable and may either extend the length of the device so that the opening is accessible at either end of the grip handle device or part of the length of the device depending on the small handheld tool it is designed to be used with. Thus, the bore and/or slit and/or cross slit may be adjustable and/or flexible for various embodiments of the adaptive grip handle devices described herein. FIGS. 21 and 2J illustrate an example system including an egg-shaped adaptive grip handle device for small, long-handled handheld tools or long-handled handheld tools with narrow diameter with adjustable bore according to one or more embodiments described herein. For example, for the variable or adjustable bore design, a large 1.75 inch diameter egg shaped adaptive grip handle device 200 may be provided with flexible and/or curled fibers 226 through the length of the bore hole 212. The flexible curled fibers 226 can be compressed by the long handled hand-held tools of a range of diameter and grip the tool to hold it in place. The fibers 226 may be “fuzzy” to grip the tool securely. Although, an adjustable bore for a large egg-shaped adaptive grip handle device is illustrated and described above, similar design may be used to provide adjustable slit and/or cross slit for a small egg-shaped and/or spherical adaptive grip handle devices according to various embodiments described herein.

FIGS. 3A-3D illustrate an example system including a spherical adaptive grip handle device for small, long-handled handheld tools or handheld tools with a narrow-diameter handle to fit a large hand according to one or more embodiments described herein.

For example, FIG. 3A illustrates side view of a spherical-shaped adaptive grip handle device 300 with a flat end 304 and a round end 302, provided with a slit 308 which may be further provided with a hole as shown in FIG. 3B, to accommodate small, handheld tool or handheld tools with a narrow-diameter handle. For example, the width and length of the device may be 1.75 inches.

FIG. 3B illustrates a view of the spherical-shaped adaptive grip handle device 300 from the flat end 304 of the device 300, showing a hole 312 which may be 2 mm to 15 mm or more, and/or a slit which may be 1.12 inch long and 1-3 mm wide, depending on the dimensions of the small, handheld tool or handheld tools with a narrow-diameter handle that the device 300 is designed to hold.

FIG. 3C illustrates a view of the spherical-shaped adaptive grip handle device 300 from the round end 302 of the device 300, showing a hole 312 which may be 2 mm to 15 mm or more, and/or a slit which may be 1.12 inch long and 1-3 mm wide, depending on the dimensions of the small, handheld tool or handheld tools with a narrow-diameter handle that the device 300 is designed to hold.

FIG. 3D illustrates a cross-sectional view of the egg-shaped adaptive grip handle device 300 showing a wall 314 and a hollow interior 316. Although the hollow interior is illustrated here, the interior of the adaptive grip handle device 300 may be hollow or solid.

Additionally, or alternatively, the bore and/or slit and/or cross slit may be adjustable and may either extend the length of the device so that the opening is accessible at either end of the grip handle device or part of the length of the device depending on the small handheld tool it is designed to be used with. Thus, the bore and/or slit and/or cross slit may be adjustable and/or flexible similar to the one illustrated in FIGS. 21 and 2J and described in the description accompanying FIGS. 21 and 2J.

FIGS. 4A and 4B illustrate examples adaptive grip handle device 400 in various shapes and sizes for small, long-handled handheld tools or handheld tools with a narrow-diameter handle such as a paintbrush according to one or more embodiments described herein. The paintbrush devices 400 are egg-shaped, ranging from 1-1.75 inch diameter at largest width, and 2.5 inch long. The flat end (which may be required for or may be a side effect of 3D printing, but may not be necessary for the working of the device) may be at the narrow end 402 of the device for easy insertion of paintbrush handle. The slit 408 at both ends is 1/16″ wide and extends down on the side of device to 0.25 inch. Bores 412, also referred to herein as holes, may be 0.0625-0.375 inch diameter to accommodate a range of dimensions of the paintbrush handles and tapers.

Devices may have 2 bores of different diameters to accommodate different diameter handles in a single device. They may be made of a flexible polymer, for example, Ninjaflex filament, and may be textured, for example, “fuzzy”, and/or may be provided with some indentation, illustrated as 418 and 418′ for easy gripping. Wall thickness may vary from 1 mm-4 mm. In any of the embodiments described herein, the adaptive grip handle device may be provided with a textured outer surface, for example, with indentations 418 and 418′, for grip surety as illustrated in FIGS. 4A and 4B.

The paintbrush device may also come in spherical shape of 1.75 inch to 2 inch diameter similar to crochet devices as illustrated in FIGS. 5A and 5B, with or without a flat end.

FIGS. 5A and 5B illustrate an example adaptive grip handle device for small, long-handled handheld tools or handheld tools with a narrow-diameter handle such as a crochet device are similar to paintbrush devices except the flat end, for example, 504, is on the large end of the egg-shaped device.

The crochet device may also come in spherical shape of 1.75 inch to 2 inch diameter as illustrated in FIGS. 5A and 5B.

Both paintbrush and crochet devices may have a cross-hair cut, also referred to herein as a cross slit, for example, 508, 508′, with a bore, which may be provided as a central bore, for example, 512, 512′ instead of a slit according to one or more embodiments described herein.

FIGS. 6A, 6B and 6C illustrate example systems including an adaptive grip handle device for small handheld tools such as a guitar pick according to one or more embodiments described herein. The guitar pick devices 600, 600′ are composed of a hard spherical outer shell 614, 614′ and flexible insert 620, 620′ with slits 610 and 610′ respectively of two different widths at either end. The shell may be textured for grip surety. The slits can accommodate standard width guitar picks 622, 622′ from 0.5 mm to 1.2 mm. The pick 622 or 622′ is inserted into the slit. When the insert 620 or 620′ is pressed into the shell 614, 614′, the slit 620 or 620′ tightens over the pick 622 or 622′, holding it firmly. The device 600 can be 1.75 inch to 2 inch diameter. Additionally, or alternatively, in one or more embodiments described herein, the insert may have an adjustable bore similar to the ones illustrated in FIGS. 21 and 2J, 226 and 226′ and described in the description accompanying FIGS. 21 and 2J.

Additionally or alternatively, in one or more embodiments, the adaptive grip handle device for small handheld tools such as a guitar pick may be an egg-shaped or spherical-shaped device adapted for use with a guitar pick, similar to the one described for a paint brush or crochet as illustrated in FIGS. 4A, 4B and 5A, 5B, which may be used without an insert.

Similarly, in one or more embodiments, adaptive grip handle device for small handheld tools such as paint brush, crochet, eating utensils, writing instruments, golf clubs etc. may be provided as a two-part device including a hard outer shell and a flexible insert including any of: a bore, a slit, a cross slit, or a combination thereof, to accommodate a range of cylindrical or flat-handled tool dimensions.

FIGS. 7A through 7H illustrate an example adaptive grip handle device for small, long-handled handheld tools or handheld tools with a narrow-diameter handle such as dental instruments according to one or more embodiments described herein. In one or more embodiments, the adaptive grip handle device 700 may be provided as one part device including any of: a flexible bore 712, a flexible slit 708, a flexible cross slit (similar to the one illustrated as 512 in FIG. 5B), or a combination thereof, that allows insertion of the small handheld tool or handheld tools with a narrow-diameter handle, as illustrated in FIG. 7A, or as a two-part device including a hard outer shell 714 and a flexible insert 720 including any of: a bore 712, a slit 712, a cross slit (similar to the one illustrated as 512 in FIG. 5B), or a combination thereof, that allows insertion of the small handheld tool or handheld tools with a narrow-diameter handle as illustrated in FIG. 7B. Additionally, or alternatively, in an embodiment, the insert may have an adjustable bore similar to the ones illustrated in FIGS. 21 and 2J, 226 and 226′ and described in the description accompanying FIGS. 21 and 2J.

In any of the embodiments described herein, the adaptive grip handle device may be provided with a textured outer surface 738 for grip surety as illustrated in FIGS. 7A and 7B.

The hard outer shell 714 of the device 700 illustrated in FIGS. 7C and 7D is egg-shaped at 2.5 inch long but may be shorter depending on tool or user with 1.75 inch diameter at widest point, bored hole 710 for insert 720 is 0.625 inch at one end, 0.75 inch at other. The device may have threads built in and compartment inside to insert weights, if necessary. The Insert 720 (with flared end) is 0.625 inch (flared to 0.75 inch) diameter, 2 inch long, with a bore 712, a slit 708, a crosswise slit (similar to the one illustrated as 512 in FIG. 5B), also referred to herein as a cross slit, or a combination thereof, at each end extending down sides of insert 720 by 0.125 inch. The shell 714 may be smaller for smaller hands (e.g., hygienists), to 1.25 inch diameter at widest point. The adaptive grip handle device 700 for dental devices may be textured for grip surety. Insert 720 may be made of a flexible polymer, for example, Ninjaflex filament, or may be disposable or autoclavable, for example, a polymer that is highly heat resistant, for example, PEEK (polyether ether ketone) 3D print filament.

Although Ninjaflex filament and PEEK 3D print filament are used here as examples, other suitable materials providing the similar functionality may be used and is also within the spirit and scope of this invention.

Additionally or alternatively, in one or more embodiments, the shell 714 may be designed to open and close lengthwise, for example, in two lengthwise halves, to accommodate two-ended dental instruments as illustrated in FIG. 7G. For example, as illustrated in FIG. 7G, the shell 714 may be provided with a narrow canal or channel like structure 730a, 730b with indentations 732a, 732b corresponding to the structural details of the dental instrument 724 to accommodate the dental instrument and a locking mechanism 728a and 728b that locks the device 700 by sliding once the dental instrument 724 is placed inside the device 700 to securely fasten the two halves together. The sliding mechanism may also be used as a release mechanism to open the device and release the tool when done. The device 700 may be provided in various shapes and sizes, 740, 750, 760, 770 etc. depending on the requirements of the user, for example, large for large hands and small for smaller hands as well as shapes depending on the requirements of the user, for example, narrow egg-shaped to almost spherical based on the flexibility of the user's hands.

Additionally, or alternatively, the adaptive grip handle device for small, long-handled handheld tools with narrow diameter such as dental instruments illustrated in FIGS. 7G-H, may be outfitted with a slip-prevention and quick-release mechanism consisting of two press-fit pins 734a and 734b, one on each side of the central groove 730, also known as a central bore. FIGS. 71 through 7K illustrate an example adaptive grip handle device for small, long-handled handheld tools with narrow diameter such as dental instruments outfitted with a slip-prevention and quick-release mechanism consisting of two press-fit pins, one on each side of the central groove according to one or more embodiments described herein. FIG. 71 illustrates a narrow end view of an example adaptive grip handle device 780 for small, long-handled handheld tools with narrow diameter such as dental instruments outfitted with a slip-prevention and quick-release mechanism. FIG. 7J illustrates a cross-section view 780′ of the narrow end of an example adaptive grip handle device 780 for small, long-handled handheld tools with narrow diameter such as dental instruments outfitted with a slip-prevention and quick-release mechanism. FIG. 7K illustrates a lengthwise cross-section view 780″ of an example adaptive grip handle device 780 for small, long-handled handheld tools with narrow diameter such as dental instruments outfitted with a slip-prevention and quick-release mechanism.

For example, the dental instrument (not shown) may be placed in the central groove of the adaptive grip handle device 730, of one half of the device, for example, 700a or 700b (which when combined form the adaptive grip handle device 780″) as illustrated in FIG. 7K, the second half, for example, 700b or 700a respectively, is clamped on top using the mechanism illustrated in FIG. 7G and described in the description accompanying FIG. 7G, and the two halves 700a and 700b may be further immobilized together using the two press-fit pins 734a and 734b as illustrated in FIGS. 71, 7J, and 7K. The two press-fit pins 734a and 734b may be of the same or different autoclavable material as the adaptive grip handle device. When the user is finished using the tool such as dental instrument, the press-fit pins 734a and 734b may be removed and autoclaved with the rest of the adaptive grip handle device 780.

FIG. 8A illustrates an example system including an adaptive grip handle device for small, long-handled handheld tools or handheld tools with a narrow-diameter handle such as eating utensils wherein a flexible slit is provided in the egg shaped or spherical shaped device that holds the eating utensils in place.

FIG. 8B illustrates an example system including an adaptive grip handle device for small, long-handled handheld tools or handheld tools with a narrow-diameter handle such as writing instruments such as pens, pencils, markers, etc. according to one or more embodiments described herein.

For example, as illustrated in FIGS. 8A and 8B, the devices 800, 800′, 800″ used for eating utensils 824, 824′ or writing instruments 824″, such as pens, pencils, may be egg-shaped, ranging from 1-1.75 inch diameter at largest width, and 2.5 inch long. The flat end (which may be required for or may be a side effect of 3D printing, but may not be necessary for the working of the device) may be at the narrow end 802 of the device for easy insertion of paintbrush handle. The slit 808 at both ends is 0.0625 inch wide and extends down on the side of device to 0.25 inch. Bores 812, also referred to herein as holes, may be 0.0625 inch to 0.75 inch diameter to accommodate a range of dimensions of the eating utensils or writing instruments such as pens, pencils etc.

As illustrated in FIG. 8B, in one or more embodiment described herein, the outside of the adaptive grip handle device is designed to result in a palmar abduction 836 of the thumb of 40°-57°. The adaptive grip handle device helps to keep the thumb and fingers in a C-position.

In any of the embodiments described herein, the adaptive grip handle device may be provided with a textured outer surface, for example, the outer surface may be fuzzy, or may be provided with some indentation, for grip surety similar to the ones illustrated in FIGS. 4A, 4B, 7A and 7B. Although, some texturing is shown in FIGS. 4A, 4B, 7A and 7B, a person skilled in art may recognize that other kind of texturing may be used for grip surety and is also within the spirit and scope of the invention.

FIGS. 9A and 9B illustrate an example system including an adaptive grip handle device for a long-handled handheld tools or handheld tools with a narrow-diameter handle such as golf club according to one or more embodiments described herein.

For example, as illustrated in FIGS. 9A and 9B, the devices 9001, 9002 used for golf club 924, may be egg-shaped or spherical, ranging from 1 inch to 1.75 inch diameter at largest width, and 2.5 inch long. The flat end (which may be required for or may be a side effect of 3D printing, but may not be necessary for the working of the device) may be at the narrow end 902 of the device for easy insertion of the golf club handle.

Additionally or alternatively, a slit may be provided similar to the slits 208 and 208′ shown in FIGS. 2C and 2G. The slit 908 (not shown here, but is similar to the slits 208 and 208′ shown in FIGS. 2C and 2G) at both ends may be 0.0625 inch wide, although the width of slit may vary and may extend down on the side of device to 0.25 inch or more. Bores 912 (not shown here, but is similar to the bores 212 and 212′ shown in FIGS. 2C and 2G), also referred to herein as holes, may be 12 mm (0.47 inch) to 15 mm (0.6 inch) diameter to accommodate a range of dimensions of the golf club shaft. Additionally or alternatively, the bore may be of one size at one end and another size at the other end to grip a flared shaft of the handheld tool, for example, a flared shaft of a golf club. In an embodiment, the extent of the slit extending down the sides of the device may be variable or optional.

As can be seen from this embodiment, more than one an adaptive grip handle device may be used with for small long-handled handheld tools or handheld tools with a narrow-diameter handle and is within the spirit and scope of the invention.

As illustrated in FIG. 9B, in one or more embodiment described herein, the outside of the adaptive grip handle device is designed to result in a palmar abduction 936 of the thumb of 40°-57°. The adaptive grip handle device helps to keep the thumb and fingers in a C-position.

Although the palmar abduction 836 and 936 of the thumb is shown in FIGS. 8B and 9B respectively, the adaptive grip handle devices for various long-handled handheld tools with small or narrow diameter, and/or small handheld tools described herein and illustrated in FIGS. 1A-7H may be designed to abduct the thumb CMC joint shown as 838 in FIG. 8B and 938 in FIG. 9B, thus preventing thumb adduction contracture, while enabling fine precision pinch function while using narrow-handled, handheld tools and utensils.

Although various dimensions are provided throughout the description, a person skilled in the art may readily recognize that they are for illustration purposes only and other dimensions that can provide best fit for the user as well as for the small handheld tool or handheld tools with a narrow-diameter handle is within the scope and spirit of the present invention.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, etc. are intended to be Inclusive, interchangeable, and/or synonymous with one another and other similar equipment for purposes of the present invention though one will recognize that functionally each may have unique characteristics, functions and/or operations which may be specific to its individual capabilities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

We claim:

1. An adaptive grip handle device for handheld tools with a narrow diameter handle, wherein the adaptive grip handle device for small handheld tools includes a rounded grip handle with an opening that allows insertion of the small handheld tool,
wherein the opening for insertion comprises any of: an adjustable bore, a flexible bore, a flexible slit, a flexible cross slit, or a combination thereof, to grip a range of handle sizes, and
wherein the bore, the slit, the cross lit or the combination thereof extends either the length of the device so that the opening is accessible at either end of the grip handle or part of the length of the device depending on the small handheld tool it is designed to be used with.

2. The adaptive grip handle device for handheld tools with a narrow diameter handle of claim 1 including any of: an adjustable bore, a flexible bore, a flexible slit, a flexible cross slit, or a combination thereof, is designed to accommodate a long-handled handheld tool with a narrow diameter.

3. The adaptive grip handle device for handheld tools with a narrow diameter handle of claim 1 is provided as either egg shaped or spherical shaped device with any of: an adjustable bore, a flexible bore, a flexible slit, a flexible cross slit, or a combination thereof, to accommodate a range of cylindrical or flat-handled tool dimensions.

4. The adaptive grip handle device for handheld tools with a narrow diameter handle of claim 1 is made of a material that can be autoclaved between uses.

5. The adaptive grip handle device for handheld tools with a narrow diameter handle of claim 1 is disposable.

6. The adaptive grip handle device for handheld tools with a narrow diameter handle of claim 1 is reusable.

7. The adaptive grip handle device for handheld tools with a narrow diameter handle of claim 2 is adapted for use with a long-handled device including any of paintbrush, a crochet needle, a dental instrument, an eating utensil, writing instrument, golf club.

8. The adaptive grip handle device for handheld tools with a narrow diameter handle of claim 1, wherein the adaptive grip handle device for handheld tools with a narrow diameter handle comprises a hard outer shell and a flexible insert, wherein the flexible insert further comprises the bore, the slit, the cross slit or a combination thereof, to accommodate a range of cylindrical or flat-handled tool dimensions.

9. The adaptive grip handle device for handheld tools with a narrow diameter handle of claim 8 is adapted for use with a guitar pick.

10. The adaptive grip handle device for handheld tools with a narrow diameter handle of claim 8 is adapted for use with a handheld tool with a narrow diameter such as paintbrush, a crochet needle, a dental instrument, an eating utensil, writing instrument, golf club.

11. The adaptive grip handle device for handheld tools with a narrow diameter handle of claim 1 is designed to open and close lengthwise to accommodate two-ended tools such as dental instruments.

12. The adaptive grip handle device for handheld tools of claim 1 is designed to be textured for grip surety.

13. A method for providing an adaptive grip handle device for small handheld tools, the method including:
providing a rounded grip handle with an opening that allows insertion of the small handheld tool,
wherein the bore or a slit for insertion comprises any of: an adjustable bore, a flexible bore, a flexible slit, a flexible cross slit, or a combination thereof, to grip a range of handle sizes, and
wherein the bore, slit, the cross slit or the combination thereof is provided such that it extends either the length of the device so that the opening is accessible at either end of the adaptive grip handle device or part of the length of the adaptive grip handle device depending on the small handheld tool it is designed to be used with.

14. The method for providing an adaptive grip handle device for handheld tools with a narrow diameter handle of claim 13 comprises providing either egg shaped or spherical shaped device comprising any of: an adjustable bore, a flexible bore, a flexible slit, a flexible cross slit, or a combination thereof, to accommodate a range of cylindrical or flat-handled tool dimensions.

15. The method for providing an adaptive grip handle device for handheld tools with a narrow diameter handle of claim 13 comprises adapting the device for use with a long-handled device with a narrow diameter handle including any of paintbrush, a crochet needle, a dental instrument, an eating utensil, writing instrument, golf club.

16. The method for providing an adaptive grip handle device for handheld tools with a narrow diameter handle of claim 13, further comprising providing a mechanism to open and close the rounded grip handle with a bore, a slit, a cross slit or a combination thereof, lengthwise to accommodate two-ended tools such as dental instruments.

17. The method for providing an adaptive grip handle device for handheld tools with a narrow diameter handle of claim 13, further comprising providing a textured outer surface for grip surety.

18. The method for providing an adaptive grip handle device for handheld tools with a narrow diameter handle of claim 13, further comprising providing the adaptive grip handle device for small handheld tools as a two-part device including a hard outer shell and a flexible insert, wherein the flexible insert further comprises any of: a bore, a slit, a cross slit or a combination thereof, to accommodate a range of cylindrical or flat-handled tool dimensions.

19. The method for providing an adaptive grip handle device for handheld tools with a narrow diameter handle device of claim 18 comprises adapting the device for use with a guitar pick.

20. The method for providing an adaptive grip handle device for handheld tools with a narrow diameter handle device of claim 18 comprises adapting the device for use with a handheld tool with a narrow diameter such as paintbrush, a crochet needle, a dental instrument, an eating utensil, writing instrument, golf club.

21. The method for providing an adaptive grip handle device for handheld tools with a narrow diameter handle of claim 13, further including designing the outside of the adaptive grip handle to result in a palmar abduction of the thumb of 40°-57°.
